(19) United States
(12) Patent Application Publication
(10) Pub. No.: US 2026/0027000 A1
(43) Pub. Date: Jan. 29, 2026

(54) DEVICE FOR STIMULATING A HUMAN EROGENOUS ZONE USING A VARIABLE PRESSURE FIELD

(71) Applicant: NOVOLUTO GmbH, Berlin (DE)

(72) Inventor: Mark Tobias Zegenhagen, Berlin (DE)

(21) Appl. No.: 19/345,860

(22) Filed: Sep. 30, 2025

Related U.S. Application Data
(63) Continuation of application No. 17/601,392.

(30) Foreign Application Priority Data
Apr. 4, 2019 (WO) PCT/DE2019/100309

(51) Int. Cl. A61H 19/00; A61H 9/00

(52) U.S. Cl. CPC A61H 19/34; A61H 9/0007; A61H 9/0057; A61H 2201/0153; A61H 2201/0157; A61H 2201/123; A61H 2201/5005

(57) ABSTRACT

A device for stimulating a human erogenous zone includes a housing; a drive device; a pressure chamber at least partially surrounded by a chamber wall; a chamber wall portion, the drive device to cause the chamber wall portion to repeatedly move between different wall positions to cause a volume of the pressure chamber to vary to cause pressure in the pressure chamber to modulate between positive pressures and negative pressures relative to an ambient pressure; a housing opening, the positive pressures and the negative pressures to be output via the housing opening; and a seal to seal the pressure chamber with respect to an ambient environment, the drive device including a coil through which an electrical current is to flow, the drive device disposed in a magnetic field and coupled to the chamber wall portion to transmit the drive movement to cause the chamber wall portion to move.

### RELATED APPLICATIONS

This patent arises from a continuation of U.S. patent application Ser. No. 17/601,392, which was filed on Oct. 4, 2021. U.S. patent application Ser. No. 17/601,392 claims the benefit under 35 U.S.C. § 371 of International Patent Application No. PCT/DE2019/100860, filed Sep. 30, 2019, which claims priority to International Patent Application No. PCT/DE2019/100309, filed Apr. 4, 2019. Priority to U.S. patent application Ser. No. 17/601,392. International Patent Application No. PCT/DE2019/100860, and International Patent Application No. PCT/DE2019/100309 is hereby claimed. U.S. patent application Ser. No. 17/601,392, International Patent Application No. PCT/DE2019/100860, and International Patent Application No. PCT/DE2019/100309 are hereby incorporated by reference in their entireties.

### FIELD OF THE DISCLOSURE

The invention relates to a device for stimulating a human erogenous zone using a variable pressure field.

### BACKGROUND

DE 10 2013 110 501 A1 describes a stimulation device having a drivetrain, an electrochemical energy storage in the form of a rechargeable battery or a battery unit, and a control unit, the drivetrain of which consists of a rotating electric motor having an eccentric shaft, a connection rod, and a piston in at least one chamber of the stimulation device. By means of the control current in the form of direct current supplied by the rotating electric motor, the rotational speed of the electric motor and thus ultimately the frequency of the piston movement is varied or controlled. The stroke of the piston is established by the defined eccentric path and thus is not modifiable during operation.

DE 10 2016 105 019 B3 describes a stimulation device, the drive unit of which “simplifies the structure” of that in DE 10 2013 110 501 A1 and is intended to generate a “higher diversity of different vibrations.” There is no rotating electric motor provided in the drivetrain here, but instead an electric linear motor with coil elements in the primary part and at least one magnetic core, which core is guided in an axially movable manner and arranged parallel to the coil element and has at least two permanent magnets arranged in an antipolar manner, as a secondary part. The magnetic core is mechanically connected to at least one actuating portion of the first chamber wall of the stimulation device. By supplying the coils or the winding of the electric linear motor or the coil elements with the supplied control current, the rotor-side magnetic core is moved axially back and forth. The maximum axial displacement path of the magnetic core is defined by the number, structure, arrangement and circuitry of the coils.

### SUMMARY

The object of the invention is to provide a device for stimulating a human erogenous zone using a variable pressure field, which allows for a device with improved operating characteristics.

To achieve the object, a device for stimulating a human erogenous zone using a variable pressure field according to the independent claim 1. The dependent claims relate to embodiments.

According to one aspect, a device is produced for stimulating a human erogenous zone using a variable pressure field. The device has the following: a housing on which a handle portion and a stimulation portion are formed; a drive device that is arranged in the housing and designed to repeatedly provide a drive movement; a pressure chamber that is arranged in the housing in order to provide a variable pressure field and is surrounded by a chamber wall at least in portions; a movable chamber wall portion that forms a portion of the chamber wall and is coupled to the drive device such that the movable chamber wall portion can repeatedly move between different wall positions in response to the drive movement coupled thereto, as a result of which a chamber volume of the pressure chamber is repeatedly increased and decreased in order to generate the variable pressure field; a housing opening that is arranged in the stimulation portion and is fluidly connected to the pressure chamber such that the variable pressure field generated by means of the pressure chamber can be dispensed via the housing opening in the form of positive and negative pressures, particularly for acting on the clitoris; a sealing device, which is allocated to the housing opening and is arranged in the region of the stimulation portion and is designed to seal off the pressure chamber from the surrounding area while in operation; and a battery device that is designed to provide a drive energy for the drive device, wherein in the drive device, a coil device, through which an electric current flows during operation, is movably arranged in an assigned stationary permanent magnetic field and is coupled to the movable chamber wall portion in order to transmit the drive movement.

A variable pressure field within the meaning of the disclosure is a media pressure field varying in terms of time and location, said field having positive and negative pressures, a negative pressure being a media pressure that is below a reference pressure, for example the ambient pressure, and a positive pressure being a media pressure that is above the reference pressure. The medium may be a medium filling the pressure chamber. The medium may be a gas or liquid. The medium may be air, for example.

By means of the sealing device, the pressure chamber is sealed off, either entirely or for the most part entirely, from the surrounding area when the housing opening is applied to a body section of an erogenous zone. For example, the sealing device may have a sealing projection, for example having a sealing bead. The sealing device may be formed in an encircling continuous manner around the housing opening. The sealing device, in particular the sealing projection, may be adapted to the shape of the housing opening, for example designed in a circular manner.

The battery device may comprise a non-rechargeable and/or a rechargeable energy storage. For example, the battery device may comprise a rechargeable battery.

In the device, the permanent magnetic field designed to be stationary may be provided by means of one or more permanent magnets. Supplementally, one or more pole plates of the arrangement may be included with the permanent magnet(s). The magnetic flux can be concentrated by means of the pole plates.

In contrast to the electromagnetic drives, in which permanent magnets are moved in an electromagnetic field generated by a coil device for generating a drive movement, in the proposed device the coil apparatus is movably arranged in a stationary magnetic field. The control current from the control unit may be applied to the movably arranged coil device. In this case, the so-called Lorentz force can act on the current-conducting coil device movably arranged in the stationary permanent magnetic field, so that the coil moves correspondingly when energized. The strength of the Lorentz force depends on the amplitude of the control current, the length of the coil, the arrangement of the coil with respect to the magnetic field and the flux density of the magnetic field in the air gap. The flux density of the magnetic field in the air gap is in turn determined for a given air gap by the magnet material as well as the magnet volume and/or magnet weight. A high flux rate of the magnetic field can be achieved in otherwise identical conditions by increasing the magnet volume and/or the magnet weight of the stationary permanent magnets, without increasing the weight of the movable coil device.

The mass to be moved can hereby be kept lower in comparison to the prior art. A lower mass can be moved more efficiently with comparatively better dynamics and be designed with fewer disruptive vibrations in the form of structure-borne sound as well as more favorable sound emissions in the form of airborne sound.

The drive device is designed as a linear drive device, which when operating generates a linear drive movement that is coupled to the movable chamber wall portion so that on the basis of its movement, the volume of the pressure chamber is repeatedly increased and decreased so that a pressure field is generated, which can be used for the contactless transmission of the stimulation of an erogenous zone. In contrast to stimulation devices in which a stimulation head is moved to transmit the stimulation waves via contact, the proposed device does not require moving such a mass of the stimulation head.

The variable pressure field generated by means of the pressure chamber may act on the erogenous zone, for example the clitoris, via the housing opening in the form of positive and negative pressures. For example, the variable pressure field generated by means of the pressure chamber acts on the erogenous zone via the housing opening when the housing opening is placed on the clitoris. The housing opening can fully or partially cover a clitoris. For example, the housing opening can cover the clitoral hood. A portion of the housing surrounding the housing opening may contact the skin. For example, the portion of the housing surrounding the housing opening may contact the clitoris and/or a skin region surrounding the clitoris. The housing portion may substantially lie in a closing manner. For example, the portion of the housing surrounding the housing opening may contact the skin such that a media movement is impeded by the housing opening. The pressure applied to the housing opening in the variable pressure field can then act on the erogenous zone. A low volume flow of the medium can hereby be made possible, which does not result in complete pressure equalization with respect to the ambient pressure at the housing opening. For example, the portion of the housing surrounding the housing opening may contact the skin in an interrupted manner in such a manner that by means of the interruptions, only a low volume flow of the medium is made possible, which does not result in complete pressure equalization with respect to the ambient pressure at the housing opening.

A chamber volume of the pressure chamber can be approximately 0.2 I at the most. Alternatively, the chamber volume of the pressure chamber can be 0.15 I at the most, alternatively 0.1 I at the most.

By sealing off the pressure chamber from the surrounding area and enclosing a small volume of air, the spring force on the linear motor increases. The spring force on the linear motor of the drive device also increases by means of the air volumes enclosed in the compact housing on the rear side of the membrane. The closed or at least largely closed volume of the housing on the rear side of the drive unit can be approximately 2 I at the most, alternatively 1 I at the most and further alternatively 0.5 I at the most.

The linear motor of the drive device is designed to generate the mentioned sought-after frequencies and pressure differentials despite the increased braking spring force by the two low volumes on the front side (pressure chamber) and rear side (housing) of the membrane.

A closed or at least largely closed volume region on the rear side of the drive device (drive unit) in the housing of the device for stimulating purposes can be approximately 2 I at the most. For this embodiment or others, a volume ratio between the volume of the pressure chamber and the (rear) volume region on the rear side of the drive unit in the housing can be approximately 1.5 at the most. Alternatively, this volume ratio can be approximately 1 at the most, and preferably approximately 0.5 at the most. This volume ration can be at least approximately 0.001. In a possible design, the information regarding the volume ratio can relate to the air-filled region in the housing, which is not occupied by other structural parts or components in the housing.

The housing opening may have a diameter of at least approximately 5 mm and at most approximately 50 mm. Alternatively, the diameter may be at least approximately 7 mm. It may be provided that the diameter is approximately 40 mm at the most. Diameter may also refer to other cross-sectional measurements of non-circular openings. In particular, the mentioned values apply both to a circular opening as well as to an oval or elliptical opening, for example. Corresponding values are then assumed for the large semi-axis of the ellipsis. The same applies correspondingly for openings of any other shapes, for example other round or angular shapes, wherein generally the size of an opening is preferably selected particularly in such a manner that the surface area of the opening corresponds to the surface of a circular opening in the range of the aforementioned dimensions.

Given a sealed pressure chamber, the drive device may be set up to generate a low-frequency pneumatic variable pressure field having an alternating frequency of approximately 0.5 Hz to approximately 150 Hz, alternatively having an alternating frequency of 1 Hz to approximately 125 Hz, or approximately 3 Hz to approximately 100 Hz. Within the meaning of the present disclosure, a variable pressure field refers to a varying pressure field, which in regard to the ambient pressure has both negative pressures as well as positive pressures, for example alternating negative pressure phases and positive pressure phases, or in another specified pattern of possibly identical or varying negative and positive pressures. This variable pressure field prevails in the pressure chamber, particularly in the region of the housing opening of the pressure chamber, i.e., parameters, such as the frequency and amplitude of the variable pressure field, are to be measured at the opening. Therefore, the term pressure field or variable pressure field refers to such a variable pressure field.

Given a sealed pressure chamber, the drive device may be designed to generate a pneumatic variable pressure field having a pressure differential between a minimum negative pressure and a maximum positive pressure of approximately 20 mbar to approximately 600 mbar, alternatively from approximately 30 mbar to approximately 400 mbar, from approximately 40 mbar to approximately 300 mbar. The pressure differential may be designed to be essentially symmetrical about an ambient pressure.

The pressure chamber may be designed to increase the chamber volume, changing from a neutral position of the movable chamber wall portion, by a volume change of approximately 1% to approximately 25%, and to decrease a volume change from approximately 1% to approximately 25%. Alternatively, the volume change may range from approximately 1.1% to approximately 15%, or from approximately 1.5% to approximately 11.5%. For this embodiment or others, in the neutral position the mount or bracket, which acts as a positioning or centering device for the support having the (moving) coil, is in a (neutral) starting or rest position, in which no deflection has occurred.

The movable chamber wall portion may have a diameter of at least approximately 5 mm and no more than approximately 60 mm. Alternatively, the diameter may be at least approximately 7 mm. The diameter may be less than or equal to 60 mm, alternatively less than or equal to 50 mm.

The battery device may be set up to provide a drive energy of alternating polarity for the coil device so that the coil device has electric current of alternating polarity passing through it to move the movable chamber wall portion about the neutral position.

Coil elements of the coil device can be arranged to encircle permanent magnets of the assigned stationary permanent magnetic field.

A regional diameter of a region, having the permanent magnets, encircled by the coil elements of the coil device may correspond at least to a diameter of the movable chamber wall portion.

The regional diameter and a diameter of the movable chamber wall portion are at a ratio of at least 0.3, alternatively at a ratio of at least 0.5 or 0.7. In other embodiments, the ratio of the regional diameter (diameter of the coil device) to the diameter of the movable chamber wall portion is at most 2, alternatively at most 1.8 or 1.5.

The movable chamber wall portion may have a flexibly deformable membrane. In this embodiment or others, the membrane may be formed of a plastics material.

The flexibly deformable membrane may have an elastic membrane portion, which, during the repeated movement of the movable chamber wall portion, is extended between the different wall positions and contracts again. Membrane portions may hereby be elastically extended and compressed. These elastic membrane portions may consist of a plastics or a rubber material for example.

The movable chamber wall portion may be formed entirely by the flexibly deformable membrane.

The movable chamber wall portion may have a rigid wall portion, which is repeatedly movable between different assigned wall positions in response to the coupled drive movement. The rigid wall portion is movable relative to the adjoining wall portions of the chamber wall. A combination of a rigid wall portion and one or more membrane portions may be provided. To enable movement of the rigid wall portion, the latter is movably integrated in the chamber wall, for example by the rigid wall portion coupling to an adjoining wall portion by means of a recessed channel or a spring element. Such a placement may be provided in general for the movable chamber wall portion.

First coil elements of the coil device may be arranged on the movable chamber wall portion. The first coil element may be arranged on the flexibly deformable membrane and/or rigid wall portion. The first coil element may be formed partially or entirely thereon. During operation, the first coil element then moves with the movable chamber wall portion.

The first coil elements may be inserted at least in portions into a membrane material of the flexibly deformable membrane. For example, the first coil element of the coil device may be molded into the membrane material. Alternatively or additionally, the first coil element may be incorporated in the membrane material between layers of said membrane material by means of a lamination process.

The movable chamber wall portion may have a wall portion having a wave shape. The wave shape of the wall portion may be elastically deformable when the movable chamber wall portion is moved during operation. The wave shape may correspond to a sine wave or a zig-zag wave for example.

At least some of the coil elements may be arranged in the region of the wave troughs and/or wave peaks of the wave shape.

Second coil elements of the coil device may be arranged on a coupling component which is coupled to the movable chamber wall portion. The second coil elements may be provided supplementally or alternatively to the first coil elements. The second coil elements may be arranged exclusively and completely on the coupling components, for example as a wire winding on a component body. For example, a moving coil construction may hereby be provided. A coil winding may be arranged on a rod-shaped component body, which, during operation, when electrical current is applied to the coil device, is immersed into the stationary permanent magnetic field and moved out of it again repeatedly in order to generate the drive movement. The drive movement provided hereby with the coupling component may be transmitted directly or conveyed via additional coupling components to the movable chamber wall portion.

The chamber wall may have an additional movable chamber wall portion which forms a portion of the chamber wall and is movable between different wall or movement positions. The additional movable chamber wall portion is formed separately from the movable chamber wall portion in the region of the chamber wall. For example, it may be arranged opposite the movable chamber wall portion. The additional movable chamber wall portion is movable or displaceable relative to the adjoining wall portions of the chamber wall. The additional movable chamber wall portion may not be coupled to the drive movement; it may be designed as a freely vibrating wall portion and thus as a sound absorption component. The coupling or integration of the additional movable chamber wall portion in the chamber wall may be designed in a comparable manner to or differently from the connection of the movable chamber wall portion; in contrast to the movable chamber wall portion, there is no coupling to the drive device. Mutual pairs of a movable and an additional movable chamber wall portion may be provided, for example such that the assigned chamber wall portions are arranged opposite each other. During operation, the additional movable chamber wall portion is optionally made to vibrate when the movable wall portion is repeatedly moved due to the drive movement.

The coil device may be at least partially arranged in an installation space between mutually opposite permanent magnets. At least in one of the operating positions, in which the coil device is moved toward the permanent magnets, the coil device may be arranged in the installation space between the mutually opposite permanent magnets. As an alternative to the design of an installation space between mutually opposite permanent magnets, it may be provided that the coil device is arranged only on one side opposite the permanent magnet or permanent magnets.

One or more permanent magnets, by means of which the assigned stationary permanent magnetic field is provided, may be arranged on the chamber wall. The permanent magnet(s) may be designed to form a chamber wall portion. The pressure chamber may be formed having multiple pressure subchambers that are fluidly interconnected. The housing opening for the variable pressure field to act on the clitoris for contactless stimulation may be arranged in a distal or end-side pressure subchamber, whereas the movable chamber wall portion, which is repeatedly moved during operation in order to generate the variable pressure field, is arranged in the region of a proximal or front-side pressure subchamber. A passage for the fluid connection is formed between adjoining pressure subchambers, which passage may have a narrowed cross-section in contrast to the fluidly interconnected pressure subchambers.

During operation, it may be possible to operate separately formed coil elements of the coil device with different electric currents. If separately formed coil elements have different electric currents flowing through them, this makes it possible to design the repeated movement of the respective coil elements during operation so as to be individual, for example in regard to deflection amplitude and/or a deflection frequency, so that variable pressure fields of different types can be generated. For example, the variable pressure field can initially be generated substantially using one of the coil elements, in order to then model this pressure field using a movable chamber wall portion which is connected to another repeatedly movable coil element when operating.

The coil device may have an upper and a lower partial coil, which are arranged on the carrier of the coil winding in a superimposed manner. The upper and lower partial coil may have electrical contacts that are separate from each other. During operation, different electric currents may be optionally applied to them. The different electric currents may hereby differ in regard to one or more current parameters, for example amplitude, polarity and/or amplitude trend over time. The upper and lower partial coil are formed separately from the movable chamber portion on the carrier.

The upper and lower partial coil may be arranged, at least in the neutral rest position, about which there is then movement or vibration during operation, opposite permanent magnets or pole plates, although an embodiment may also be provided in which one of the partial coils is opposite permanent magnets, whereas the other partial coil is arranged opposite the pole plate.

In the various embodiments, the permanent magnets may be arranged on the inside or outside in relation to the coil windings. An arrangement of the permanent magnets below the coil winding(s) is also possible.

It may be the case that before operation, in which the movable chamber wall portion is moved forward and back (or up and down) in relation to the starting position, the coil winding(s) arranged on the carrier are moved (deflected) out of a neutral rest position to then be moved or displaced about this relocated position during operation. During operation, a current with a non-alternating polarity can be applied to the coil, which simplifies the electrical power supply. Such a preliminary movement or deflection may occur against a pretensioning device, which provides a pretensioning force against the deflection, for example a spring mechanism. During operation, the pretensioning device providing the pretension may have an assisting effect on moving the coil device and thus the movable chamber wall portion.

According to another aspect, a method for generating a variable pressure field is created that has the following steps: providing a stimulation device having a housing to which are formed a grip portion and a stimulation portion; the repeated providing of a drive movement by means of a drive device that is arranged in the housing; providing a variable pressure field in a pressure chamber that is arranged in the housing and is enclosed at least sectionally by a chamber wall; moving a movable chamber wall portion that forms a portion of the chamber wall and is coupled to the drive device in such a manner that the movable chamber wall portion is moved repeatedly between various wall positions as a response to the drive movement coupled to said chamber wall portion, by means of which a chamber volume of the pressure chamber is repeatedly increased and decreased to generate the variable pressure; action of the variable pressure field in the form of negative and positive pressures on the clitoris by means of a housing opening that is arranged in the stimulation section and is fluidically connected to the pressure chamber in such a manner that the variable pressure field generated by means of the pressure chamber can be emitted via the housing opening in the form of negative and positive pressures; and providing a drive energy for the drive device by means of a battery device, wherein in regard to the drive device, a coil device, which has an electric current flowing through it when operating, moves in an assigned stationary permanent magnetic field and couples to the movable chamber wall portion for transmitting the drive movement.

According to another aspect, a device is produced for stimulating a human erogenous zone, particularly the clitoris, using a variable pressure field. The device has the following: a housing to which are formed a grip portion and a stimulation portion; a drive device, which is arranged in the housing and is designed to repeatedly provide a drive movement; a pressure chamber that is arranged for providing a variable pressure field in the housing and is at least sectionally surrounded by a chamber wall; a movable chamber wall portion, which forms a portion of the chamber wall and couples to the drive device in such a manner that the movable chamber wall portion can be repeatedly moved between various wall positions in response to the drive movement coupled to said chamber wall portion, by means of which a chamber volume of the pressure chamber for generating the variable pressure field is repeatedly increased and decreased; a housing opening that is arranged in the stimulation portion and is fluidically connected to the pressure chamber in such a manner that the variable pressure field generated by means of the pressure chamber can be emitted via the housing opening in the form of positive and negative pressure, particularly for acting on the clitoris; and a battery device that is designed for providing drive energy for a drive device, wherein in regard to the drive device, a coil device, which has electrical current passing through when in operation, is movably arranged in an allocated stationary permanent magnetic field and couples to the movable chamber wall portion for transmitting the drive movement. A chamber volume of the pressure chamber is hereby approximately 0.2 I at the most.

In connection with the method for generating a variable pressure field by means of the stimulation device, the previously discussed embodiments may be provided correspondingly.

During operation, an electric current is applied to the coil device, the frequency and/or amplitude of which current are adjusted by a control device.

### BRIEF DESCRIPTION OF THE FIGURES

Additional embodiments are described in greater detail below with reference to figures of a drawing. In the figures:

FIG. 1a is a schematic representation of a device for stimulating an erogenous zone using a variable pressure field in a front view;

FIG. 1b is a cross-sectional view of the device for stimulating an erogenous zone from FIG. 1a;

FIG. 2 is a schematic representation of arrangements for a stimulation device having a pressure chamber, which is formed having one or two pressure subchambers;

FIG. 3 is a schematic representation of arrangements for a stimulation device having two pressure subchambers each;

FIG. 4 is a schematic representation of an arrangement for a stimulation device, in which a double drive is provided;

FIG. 5 is a schematic representation of an arrangement for a stimulation device, in which two actively movable chamber wall portions are provided in the region of the pressure chamber;

FIG. 6 is a schematic representation of arrangements for a stimulation device, in which coil elements are integrated in a movable chamber wall portion;

FIG. 7 is a schematic representation of an arrangement for a stimulation device, in which coil elements are also integrated in the movable chamber wall portion;

FIG. 8 is a schematic representation of arrangements for a stimulation device having a pressure chamber, which has two pressure subchambers, coil elements being integrated in a movable chamber wall portion;

FIG. 9 is a schematic representation of an arrangement for a stimulation device, in which, in contrast to the design in FIG. 9, the pressure subchambers are connected to each other by means of a lateral passage;

FIG. 10 is a schematic representation of arrangements for a stimulation device, one or two additional movable chamber wall portions being provided;

FIG. 11 is a schematic representation of arrangements for a stimulation device, in which the pressure chamber has two interconnected pressure subchambers;

FIG. 12 is a schematic representation of arrangements for a stimulation device, in which a movable chamber wall portion is arranged between permanent magnets;

FIG. 13 is a schematic representation of arrangements for a stimulation device, in which a movable chamber wall portion has a wave shape;

FIG. 14 is a schematic representation of arrangements for a stimulation device, in which the movable chamber wall portion has a wave shape, the pressure chamber being formed having two pressure subchambers;

FIG. 15 is a schematic representation of an arrangement for a stimulation device, in which, in contrast to the design in FIG. 15, two pressure subchambers are interconnected via a lateral passage;

FIG. 16 is a schematic representation of arrangements for a stimulation device, in which the movable chamber wall portion has a wave shape, additional movable chamber wall portions being provided;

FIG. 17 is a schematic representation of an arrangement for a stimulation device, a movable chamber wall portion having a wave shape being arranged between two permanent magnets;

FIG. 18 is a schematic representation of an arrangement for a stimulation device, in which the coil device has separate coil windings and permanent magnets are arranged on the outside;

FIG. 19 is a schematic representation of an arrangement for a stimulation device, in which the coil device has separate coil windings and permanent magnets are arranged on the inside;

FIG. 20 is a schematic representation of an arrangement for a stimulation device, in which the coil device has separate coil windings and permanent magnets are arranged on the outside at the top;

FIG. 21 is a schematic representation of an arrangement for a stimulation device, in which the coil device has separate coil windings and permanent magnets are arranged on the outside on the bottom;

FIG. 22 is a schematic representation of an arrangement for a stimulation device, in which permanent magnets are arranged on the inside in relation to the moving coil;

FIG. 23 is a schematic representation of an arrangement for a stimulation device, in which permanent magnets are arranged on the outside in relation to the moving coil;

FIG. 24 is a schematic representation of an arrangement for a stimulation device, in which the permanent magnets are arranged underneath in relation to the moving coil;

FIG. 25 is a schematic representation of an arrangement for a stimulation device, in which the moving coil is first moved out of a neutral rest or starting position;

FIG. 26 is a schematic representation of an additional arrangement for a stimulation device, in which the moving coil is first moved out of a neutral rest or starting position; and

FIG. 27 is a schematic representation of a different arrangement for a stimulation device, in which the moving coil is moved from a neutral rest or starting position.

### DETAILED DESCRIPTION

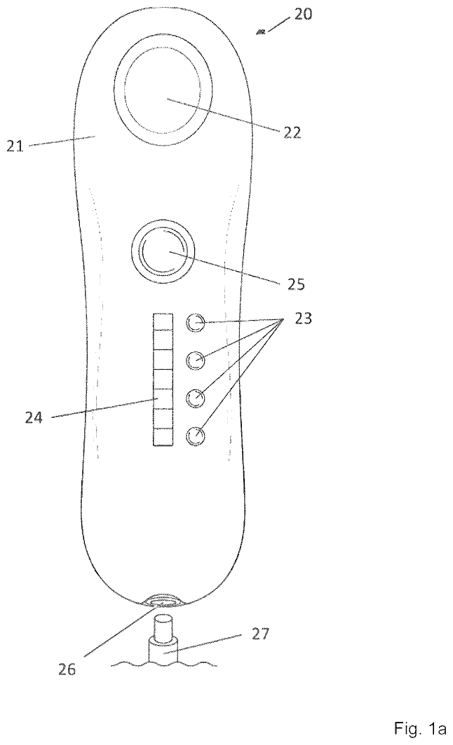

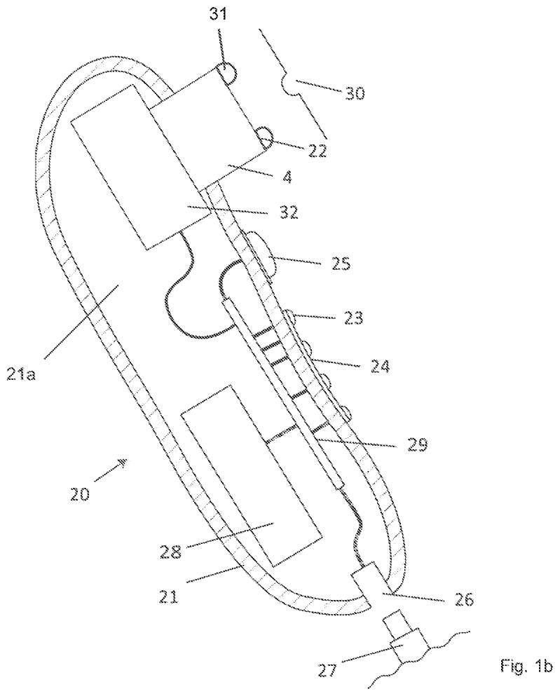

FIG. 1a is a schematic representation of a device for stimulating (stimulation device) an erogenous zone using a variable pressure field in a front view; FIG. 1b shows the stimulation device in a cross-sectional view.

The stimulation device 20 is a, for example portable, electrical or small device, which has a housing 21, a housing opening 22 for placing onto the clitoris 30 for example, operating elements 23, a display 24, an on-off switch 25, an optional socket 26 and a battery device 28, for example having a rechargeable battery.

A sealing device 31 is provided, which in the depicted embodiment is formed with a sealing bead. While in operation, the sealing device 31 seals off the pressure chamber 4 from the surrounding area or nearly seals it off in such a manner that a variable pressure field can be generated in the pressure chamber 4.

The housing 21 may be ergonomically designed in such a manner that it can comfortably be held with one hand and has no sharp or pointed edges. Furthermore, the housing 21 may consist of plastics material, for example polycarbonate (PC) or acrylonitrile butadiene styrene (ABS). In addition, the handle regions or the entire housing 21 may be supplemented or provided with a haptically advantageous silicone, for example in the form of a silicone coating. The housing 21 may be designed to be at least water-repelling or water spray-repelling, for example with protection rating IP 24. Furthermore, the stimulation device 20 may be designed to be waterproof against immersion under water.

The operating element 23 or the operating elements 23 are used to adjust the operating mode of the device, i.e., adjusting the modulation of the variable pressure field. For example, the operating elements 23 may comprise at least one push button as well as at least one rotary switch, or at least one touch-sensitive switch. Furthermore, the operating elements 23 may emit visual feedback regarding actuation, for example by means of integrated light-emitting diodes (LEDs).

An optional display 24 is used to inform the user about the device status and/or the setting status. For example, the display 24 may be designed using one single light-emitting diode, a plurality of light-emitting diodes or as an LCD display. The displayed information may be for example the switched-on state of the device, the charge state of the battery device 28 or the current setting of the modulation of the pressure field.

The on-off switch 25 is used to activate and deactivate the stimulation device 20. This on-off switch 25 may be for example a push button, which turns the stimulation device 20 on or off when pressed for longer, or a latching slide switch.

A socket 26 is used for the external power supply to the stimulation device 20 via an external plug 27, which for example is connected to an external power adapter. To ensure water spray resistance of the stimulation device 20, instead of the socket 26 a magnetic-inductive transformer may be provided, which allows power transmission into the stimulation device 20 without an electrically conductive contact. The stimulation device 20 also has a battery device 28, having for example a rechargeable battery, for example a nickel metal hydride (NiMH) rechargeable battery, or a lithium rechargeable battery, for wireless operation. Alternatively or additionally, a (longer) power supply cable may lead out of the stimulation device. Likewise, alternatively or additionally, the magnetic contacts may be provided as a power supply terminal.

The schematic cross-section in FIG. 1b shows the housing opening 22 for placing on the clitoris 30, a pressure chamber 4, as well as the drive device 32 of the stimulation device 20.

A control device 29 controls the drive device 32, the operating elements 23 and the display 24. The control device 29 and the drive device 32 are supplied with power from the internal battery device 28 and/or the external power supply 27. The control device 29, which for example has a microcontroller or is hardwired, first controls the power supply of all loads of the stimulation device 20, and optionally a charging and discharging process of the battery device 28 and/or battery management. In particular, the control device 29 controls the drive unit 32, for example the modulation of the pressure field and so on. Furthermore, the control device 29 may have a memory, in which at least one modulation or stimulation pattern is stored. The excitation of the drive device 32 can now be controlled as chosen by the user of the stimulation device 20 according to this prestored stimulation pattern via the operating elements 23. The stimulation patterns of the pressure field may optionally also be individually generated and stored by the user via the operating elements.

A volume ratio between the volume of the pressure chamber 4 and a (rear-side or remaining) volume region 21 on the rear side of the drive unit 32 in the housing is for example no more than approximately 1.5 in the various embodiments.

For the closed or at least largely closed volume region 21a of the housing 21 on the rear side of the drive unit 32, there may be a volume of no more than approximately 2 I, alternatively no more than 1 I and further alternatively no more than approximately 0.5 I.

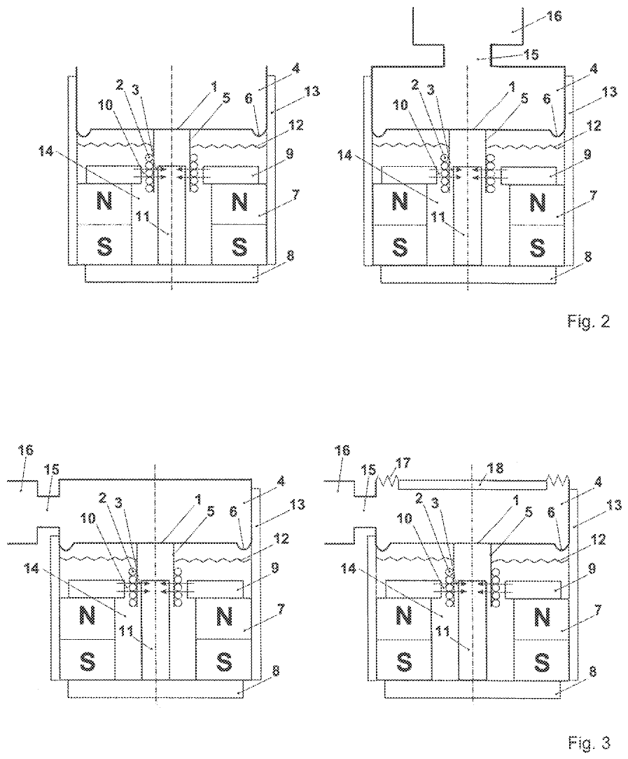

Embodiments for an arrangement for a stimulation device or arrangements for the drive unit 32 and the pressure chamber 4 are described below with reference to FIGS. 2 to 17, in each of which arrangements coil elements of an electromagnetic linear drive are moveably or movably arranged in a stationary permanent magnetic field.

In the arrangements depicted in FIG. 2, a movable wall portion 1 connected to a carrier 5 is moved back and forth by at least one moving or plunger coil 2, attached to said carrier, corresponding to a coil power supply input by means of the control current in a magnetic field 3 provided by permanent magnets, in order to thereby move the wall portion 1 back and forth during operation in order to thereby generate a variable pressure field.

The movable wall portion 1 (for example made of a polymer or paper) as part of a pressure chamber 4 of the stimulation device is attached to the carrier 5 (for example made of aluminum, Kapton, or an aluminum-Kapton laminate). The movable wall portion 1 may be integrated into the chamber by means of a recessed channel 6, which mechanically follows the strokes of the movable wall portion 1 to the greatest extent possible without any mechanical strain. Wrapped around the carrier 5 are coil elements of a moving coil 2, which during operation are supplied with power by the control current from a control unit. The moving coil 2 consists of electrical conductors made of a material having the greatest electrical conductivity possible (for example copper or silver), which are insulated from each other and the carrier 5 by means of an electrically insulating lacquer. The magnetic field is provided by at least one permanent magnet 7, which may have a ring shape. The magnetic flux is carried by means of pole plates 9, which have a rear pole plate 8 (for example, as in FIG. 2, having a cylindrical shape) and an upper pole plate 9a (for example, as in FIG. 2, having a ring shape) across a, for example, ring-shaped air gap 10 to the cylindrical pole core 11. Just like the pole core 11, the rear pole plate 8 and upper pole plate 9 are made of a magnetic, highly permeable material (for example a soft magnetic material alloy).

For the inductance of the structurally narrowest air gap possible between the upper pole plate 9a and the pole core 11, the permanent magnet 7 requires as high a flux density as possible, which is why the strongest possible permanent magnets having flux densities of approximately 0.4 to approximately 1.2 T (for example, neodymium-iron-boron magnets) are used, which generate strong magnetic fields and have a low weight.

The carrier 5 with the moving coil 2 is, if applicable, structurally centered and guided in the air gap 10 by means of at least one bracket or mount 12 (for example, made of plastics material, textile fabric or paper) to prevent wobbling motions of the moving coil 2. The bracket or mount 12 is attached to a frame 13 (for example, made of plastics material, aluminum or magnesium). Alternatively, the wobble motion of the moving coil 2 can also be prevented by a guide on the pole core or the permanent magnet.

To move the movable wall portion 1, the moving coil 2 is supplied with power by a control alternating current from a control unit. Depending on the current direction or current polarity in the magnetic field of the air gap 10, the moving coil 2 is moved upward or downward by the Lorentz force. The directions of the Lorentz force, the magnetic field and the current flow are perpendicular to each other in FIG. 2. The stroke of the deflection of the moving coil 2 is determined by the amplitude of the control current. The frequency of the alternating current corresponds to the frequency of the moving coil motion and thus the frequency of the movement of the movable wall portion 1. The frequency and the stroke of the moving coil and thus the movement of the movable wall portion 1 may be controlled independently of each other in a comparatively simple manner by the current frequency and the current amplitude. The changing pressure field and the resulting variable positive and negative pressure at the erogenous body zone (clitoris) can be controlled independently of each other by the alternating compression and expansion of air from the motion of the movable wall portion 1 (or of multiple movable wall portions when operating), in other words in terms of frequency and amplitude.

Based on the direct transmission, an expanded frequency range from less than 1 Hz to several hundred Hz is easily possible using this principle. The direct current from the rechargeable battery must only be converted into alternating current. Conversion into an alternating current may comprise the turning on and off and/or the superimposition of direct current portions. An alternating current voltage can hereby be provided using a direct current offset. For example, an alternating current voltage may be provided which does not comprise any polarity change, but only a change of the voltage level given a constant voltage direction (polarity).

According to the image on the right in FIG. 2, the arrangement may have a pressure chamber with multiple pressure subchambers, with an additional pressure chamber 16 provided next to pressure chamber 4, so that connected pressure subchambers are provided that are connected via a connection channel 15. The housing opening for enabling the variable pressure to act on the erogenous zone is provided on the additional pressure chamber 16. The pressure chamber 4 and the additional pressure chamber 16 are also provided in the embodiment in FIG. 3.

Generating the variable pressure field by moving the movable wall portion 1 (and thus the positive and negative pressure) is accompanied by sounds being generated, i.e., local pressure fluctuations in the air, which can be heard by the human ear and propagate at the speed of sound. By means of suitable absolute dimensioning of the chamber volume of the pressure chamber 4 and the (remaining) volume 21a of the housing 21 as well as the ratio of these volumes taking into consideration the matching of the linear drive as well as the configuration of the coil elements and membrane of the movable wall portion 1 to achieve a high base resonance frequency while in operation, the generation of airborne sound is largely suppressed. Furthermore, the sounds inherent with the movement of the movable wall portion 1 may be absorbed, i.e., the sound energy can be converted into heat.

In FIG. 3 (right-hand side), the sounds are dissipated in the air as heat according to the absorption principle of a plate transducer by the friction in at least one of the chamber walls 18, which is formed with another movable wall portion, as well as by the friction of the vibrating chamber wall. The chamber wall 18 vibrating for sound absorption purposes is also integrated into the chamber by a spring device 17 acting in a spring-like manner. Acoustic energy is ultimately transformed into heat and dissipated by the deformation of the spring and the thus generated friction in the spring device 17. The plate transducer is a narrow-band resonance absorber, the weight and spring deflection of which are to be selected such that the characteristic absorber frequency for a preferably high level of sound absorption as a function of the sound frequency is preferably near or in the frequency range of the movement of the movable wall portion 1. In addition, the sounds created by the piston or membrane movement are to be dissipated as heat into a porous structure according to the absorption principle.

The chamber walls 18 may be formed having a porous structure and may be integrated in the plate transducer for example or alternatively mounted on the plate transducer. The sounds are absorbed by means of the viscous current losses of the air through friction on the porous damping material and the friction from the deformation of the material. The porous absorber is a broad-band absorber, the coating thickness and material of which are to be selected such that the characteristic absorber frequency for the highest possible level of absorption is near or in the frequency range of the movement of the movable wall portion 1. By means of the absorption according to the plate transducer principle or in a porous structure, sound propagation is reduced as much as possible.

The drive unit is formed with few movable, low-weight components and therefore has few unbalanced free inertial forces to initiate oscillations or vibrations of the components or the housing of the stimulation device at certain movable wall portions. By means of the low weight, a highest possible fundamental resonance of the movable part of the drive device 32 is achieved. In addition, as shown in FIG. 3, the other movable wall portion of the chamber wall 18 can be designed optionally to have a ferrofluid 14 for damping the resonances of the moving coil 2 and a frame 13 or an enclosed chamber (not completely filled), as a result of which the cooling of the moving coil 2 and the carrier 5 is also improved by the increased heat conduction compared to air. The heat capacity of the intentionally lightweight-built moving coil 2 and carrier 5 is low.

The flexibility in the design of the drive allows a large amount of freedom in designing the stimulation device to shape the drive in an elongated or wide manner, the shifting of the fundamental resonance of the movable portions of the linear drive for suppressing the airborne sound, and to also decrease the local pressure fluctuations propagating at the speed of sound by means of sound absorption measures in the chamber (cf. FIG. 3). Furthermore, measures similar to noise absorption can also be used in the volume of the housing 21 on the rear side of the movable pressure chamber wall portion 1.

The drive unit or device has a comparatively low complexity due to the direct conversion of the electrical energy from the battery unit 28, for example from the rechargeable battery, into a translational movement of a simple moving coil coupled to the movable wall portion 1, which may be formed in the various embodiments—regardless of the actual drive—for example having a piston, a rigid wall portion and/or a membrane, which may be made of an elastic material at least in portions. The direct conversion also results in potentially higher efficiency, compact construction and low weight.

The movable wall portion(s) 1 may be designed as an integral component of the chamber (pressure chamber—chamber, in which the variable pressure field is generated), as a result of which a good seal is ensured against compressible and non-compressible media up to a certain positive and negative pressure of the chamber.

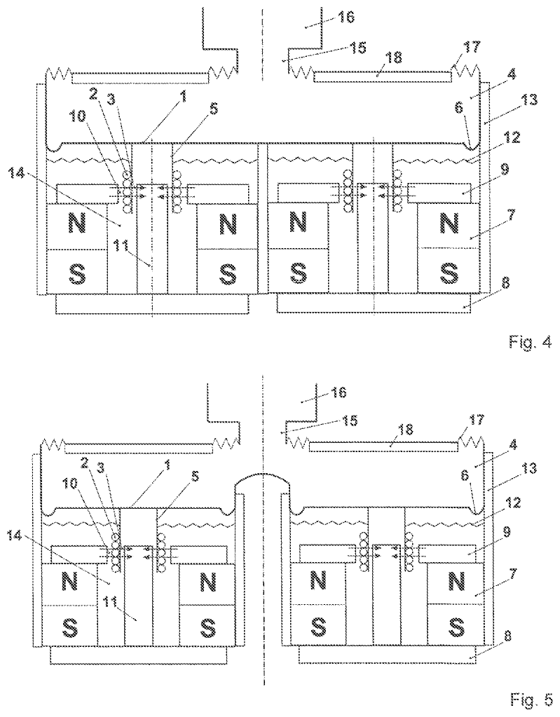

To keep constant or increase the surface-specific force resulting from the carrier 5 on the movable wall portion 1 while simultaneously having a wide or flat design of the drive (i.e., with a compact moving coil 2 and the carrier 5), the movable wall portion 1 can be moved by means of more than one coil 2 and more than one carrier 5, as depicted in FIG. 4.

The flexibility of the drive at a constant or increased specific surface force on the movable wall portion 1 is also increased in the embodiment from FIG. 5. For absorption purposes, devices according to the plate transducer principle 17 or in the form of porous structures 18 are also provided here.

The sounds emitted on the rear side of the movable wall portion 1 are absorbed in all embodiments for example by a device according to the plate transducer principle or in a porous structure, and thereby reduced to the largest extent possible (not depicted).

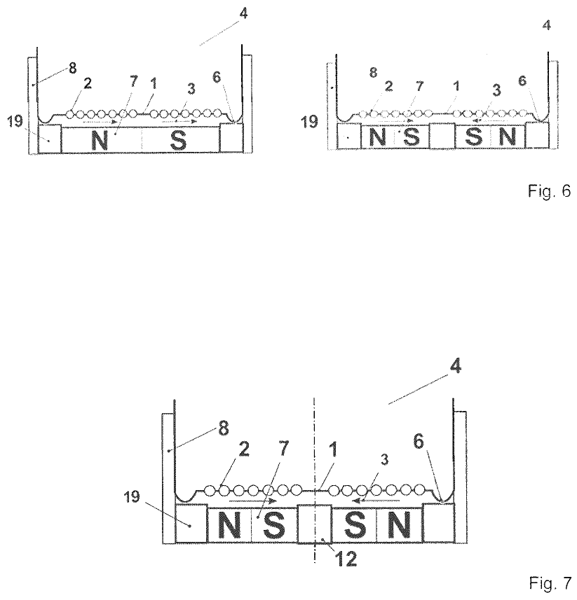

In the arrangement depicted in FIG. 6, fine conductors of the coil 2, through which conductors current flows, are located directly on at least one movable wall portion 1.

On at least one side of the movable wall portion 1, there is at least one permanent magnet 7, for example in the form of a bar magnet as shown in FIG. 6. For the inductance of the air gap 4 to be kept as structurally narrow as possible between the permanent magnet 7 and the movable wall portion 1 having the electrical conductors 2, the permanent magnet 7 requires the highest possible flux density, which is why the strongest possible permanent magnets with flux densities of 0.4 . . . 1.2 T (for example neodymium-iron-boron magnets) are used, which generate a strong magnetic field 3 and have a low weight. The movable wall portion 1 (for example made of a polymer or paper) as part of a first chamber of the stimulation device 20 may be integrated into the chamber by means of a recessed channel, which mechanically follows the strokes of the movable wall portion 1 to the largest extent without mechanical loads. The electrical conductors 2 on the movable wall portion 1 are made of the most electrically conductive material possible (for example copper or silver) and electrically insulated from each other by integration into the movable wall portion 1. The magnetic flux is carried by means of lateral pole plates 19 (for example, as in FIG. 6, in a rod shape) across the air gap 4. The lateral pole plates 19 are made of a material having high magnetic permeability (for example, a soft magnetic material alloy). The chamber of the stimulation device 20, the permanent magnet 7 as well as the lateral pole plates 19 are attached to a frame 8 (for example made of plastics material, aluminum or magnesium).

To move the movable wall portion 1, the thin electrical conductors 2 are supplied with a control alternating current from a control unit. The electrical conductors 2 are moved upward or downward by the Lorentz force depending on the current direction or current polarity in the magnetic field of the air gap 4. The drive forces engage uniformly with the entire surface of the movable wall portion 1. The directions of the Lorentz forces, the magnetic field and the current flow are perpendicular to each other in FIG. 6. In the variant with two permanent magnets arranged in an antipolar manner in FIG. 6 (right-hand side), the electrical conductors must be supplied with power via the two permanent magnets 7 each having a different polarity in order to effect the same movement.

The stroke of the deflection of the electrical conductors integrated in the movable wall portion 1 is determined by the amplitude of the control current. The frequency of the alternating current corresponds to the frequency of the conductor movement and thus the frequency of the movement of the movable wall portion 1. The frequency and the stroke of the movable wall portion 1 can thus be controlled independently of each other in a comparatively simple manner by the current frequency and current amplitude. The variable pressure field and the resulting positive and negative pressure on the erogenous body zone (clitoris) can be controlled independently of each other by the alternating compression and expansion of the air through the movement of the movable wall portion 1, in other words in terms of frequency and amplitude.

Due to the direct transmission, an expanded frequency range from below 1 Hz to several hundred Hz is possible using this principle. The direct current from the rechargeable battery must only be converted into alternating current. The conversion into an alternating current may comprise the turning on and off and/or the superimposition of direct current portions. An alternating current voltage having a direct current offset can hereby be provided. For example, an alternating current voltage can be provided that does not comprise any polarity change, but only a change of the voltage level given a constant voltage direction (polarity).

Alternatively, the drive unit may also be designed in a ring shape as depicted in FIG. 7.

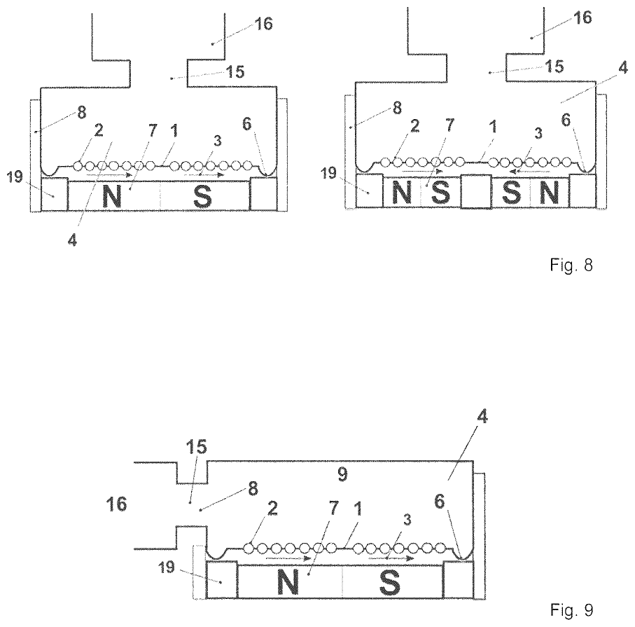

In the electromagnetically planar ring-shaped transformer, the membrane is circular. The permanent magnet 7, the electrical conductors 2, the lateral pole plate 19 as well as the bracket are ring-shaped, for example. In the symmetrical axis of the drive unit, a pole core 11 is provided to better control the magnetic field. Alternatively, the drive unit may also be connected via a connection channel 10 to a second chamber 11, as depicted in FIG. 8.

Alternatively, also as in FIG. 9, there may be at least one second chamber 11 on the side of the drive unit.

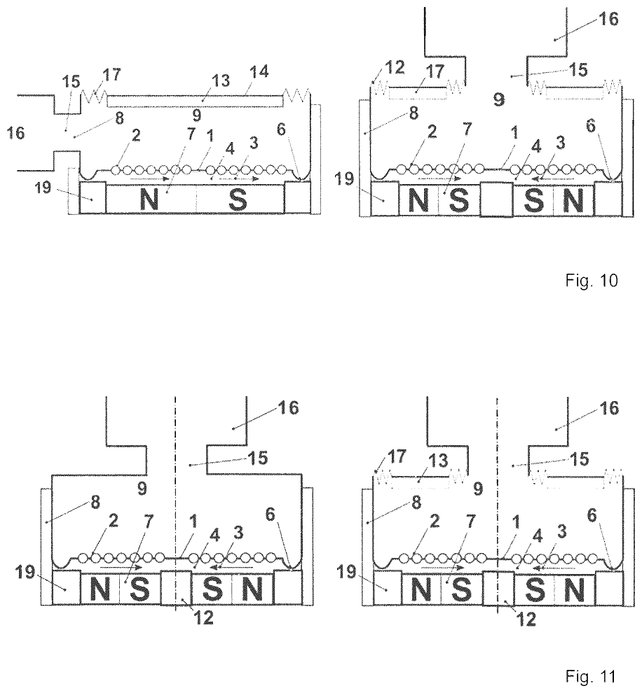

In one embodiment having a second chamber 11 on the side (left) or opposite (right) of the movable wall portion 1, sound-absorbing devices may be provided according to the plate transducer principle or in a porous structure, as in FIG. 10.

By means of the sound-absorbing devices, the sound propagation inherent with the movement of the movable wall portion 1 is reduced to the greatest extent possible.

Alternatively, the two-chamber embodiments from FIG. 9 (right) and FIG. 10 (right) may also be ring-shaped.

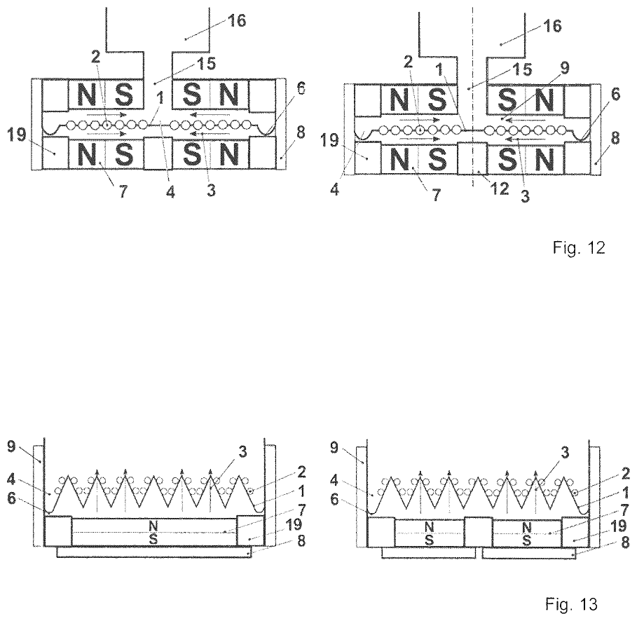

To generate the highest possible flux density in the air gap 4 to be kept as structurally narrow as possible and to thereby keep constant or increase the surface-specific force on the movable wall portion 1, permanent magnets 7, as depicted in FIG. 12, may alternatively be arranged on both sides of the movable wall portion 1.

The design of the drive with permanent magnets 7 on both sides of the movable wall portion 1 in FIG. 12 may be executed with two permanent magnets arranged in an antipolar manner in each case above and below the movable wall portion 1 (left) or alternatively with two ring-shaped permanent magnets above and below the movable wall portion 1 (right).

The sounds emitted on the rear side of the movable wall portion 1 are absorbed in all embodiments for example by a device according to the plate transducer principle or in a porous structure, and thereby reduced to the largest extent possible (not shown).

In the electromagnetic transformer depicted in FIG. 13, fine conductors, through which current flows, are located directly on the movable wall portion 1, which has at least one thin membrane, which is folded in a lamella shape (lamellar membrane).

On at least one side of the lamellar membrane, there is at least one permanent magnet 7 (left) for example in the form of a bar magnet, as shown in FIG. 13. For the inductance of the air gap 4 to be kept as structurally narrow as possible between the permanent magnet 7 and the lamellar membrane with the electrical conductors 2, the permanent magnet 7 requires the highest possible flux density, which is why the strongest possible permanent magnets with flux densities of 0.4 . . . 1.2 T (for example neodymium-iron-boron magnets) are used, which generate a strong magnetic field 3 and have a low weight. The lamellar membrane (for example made of a polymer, e.g., polyamide, polyester or polyimide) as part of a first chamber of the stimulation device 20 may be integrated in the chamber by means of a recessed channel, which mechanically follows the travel of the movable wall portion 1 largely without mechanical loads. The electrically insulated conductors 2 on the lamellar membrane are made of the most electrically conductive material possible (for example copper or silver) and bonded onto the lamellar membrane for example. The magnetic flux is carried by means of lateral pole plates 19 (for example, as in FIG. 13, in a bar form) across the air gap 4. The lateral pole plates 19 are made of a material having high magnetic permeability (for example a soft magnetic material alloy). The chamber of the stimulation device 10, the permanent magnet 7 and the lateral pole plates 19 are attached in a frame 9 (for example made of plastics material, aluminum or magnesium).

As shown in FIG. 13, the lamellar membrane is overlaid in a meandering manner with parallel-running electrical conductor paths 2. The current flow direction must be identical for all conductor paths since the magnetic field 3 also has the same direction everywhere in the air gap 4 to be kept as structurally narrow as possible. On the lamellar membrane, the electrical conductors 2 are guided in a meandering manner in such a way that the adjoining lamella each have current flowing through them in the opposite direction. To move the lamellar membrane 1, the thin electrical conductors 2 are supplied with energy using a control alternating current from a control unit. Depending on the current flow direction or the polarity, the lamella move based on the Lorentz force toward or away from each other and press the air out of their intermediate space or suck it in. Alternatively, the movement of the lamellar membrane can also be achieved with an alternating current voltage, which does not comprise any polarity change, but only a change of the voltage level while the voltage direction (polarity) remains constant. By the folding into a lamellar shape, a significantly increased membrane surface becomes active. Despite the comparatively large membrane surface, the entire membrane surface is driven uniformly. Alternatively, multiple permanent magnets 7 in FIG. 13 (right) can be arranged under the lamellar membranes.

The stroke of the deflection of the electrical conductors integrated in the lamellar membrane is determined by the amplitude of the control current. The frequency of the alternating current corresponds to the frequency of the conductor movement and thus the frequency of the movement of the lamellar membrane. The frequency and the stroke of the lamellar membrane movement can thus be controlled independently of each other in a comparatively simple manner using the current frequency and current amplitude. The variable pressure field and the resulting positive and negative pressure on the erogenous body zone (clitoris) can be controlled independently of each other by the alternating compression and expansion of the air through the movement of the pulling together and pushing apart of the lamellar membrane, in other words in terms of frequency and amplitude.

Due to the direct transmission, an expanded frequency range from less than 1 Hz to several hundred Hz is possible using this principle. The direct current from the rechargeable battery must only be converted into alternating current. Conversion into an alternating current may comprise the turning on and off and/or the superimposition of direct current portions. An alternating current voltage can hereby be provided using a direct current offset. For example, an alternating current voltage may be provided which does not comprise any polarity change, but only a change of the voltage level given a constant voltage direction (polarity).

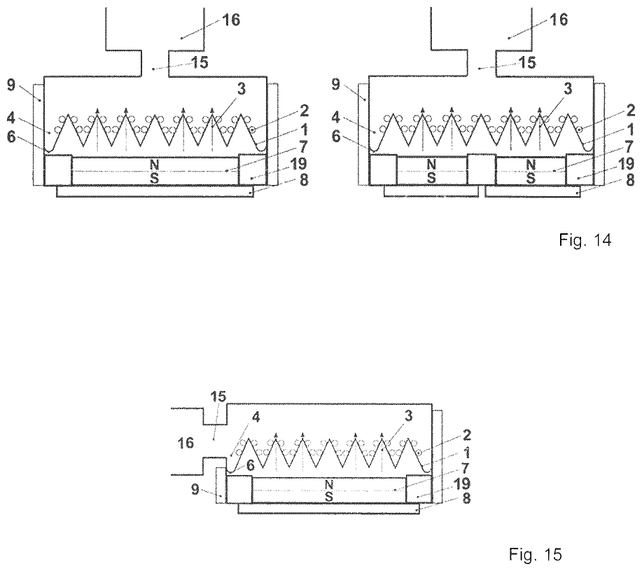

Alternatively, the drive unit may also be connected via the connection channel 15 to the additional chamber 16, as depicted in FIG. 14.

Alternatively, as in FIG. 15, there may also be at least one second chamber 16 on the side of the drive unit.

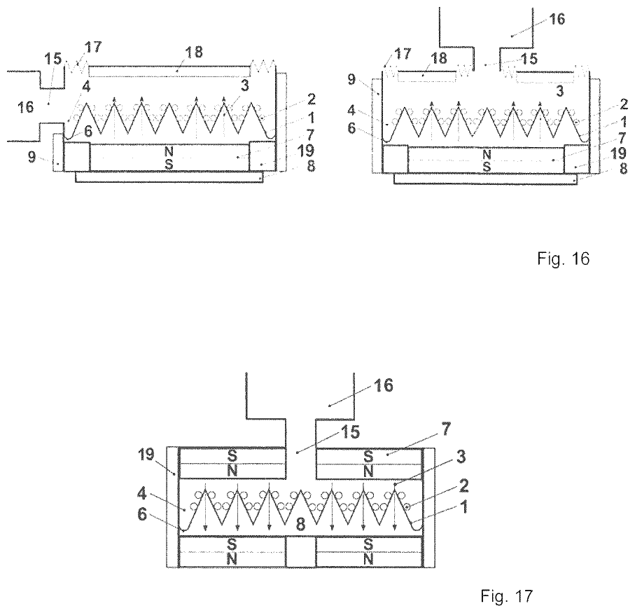

In one embodiment having a second chamber 16 on the side (left) or opposite (right) of the movable wall portion 1, sound-absorbing devices may be provided according to the plate transducer principle or in a porous structure, as in FIG. 16.

To generate the highest possible flux density in the air gap 4 to be kept as structurally narrow as possible and to thereby keep constant or increase the surface-specific force on the movable wall portion 1, permanent magnets 7, as depicted in FIG. 17, may alternatively be arranged on both sides of the movable wall portion 1.

In FIG. 17, the movable wall portion 1 is located directly between poles of the permanent magnets 7 and may also be designed having multiple permanent magnets 7 side by side.

The sounds emitted on the rear side of the movable wall portion 1 are absorbed in all embodiments for example by a device according to the plate transducer principle or in a porous structure, and thereby reduced to the largest extent possible (not shown).

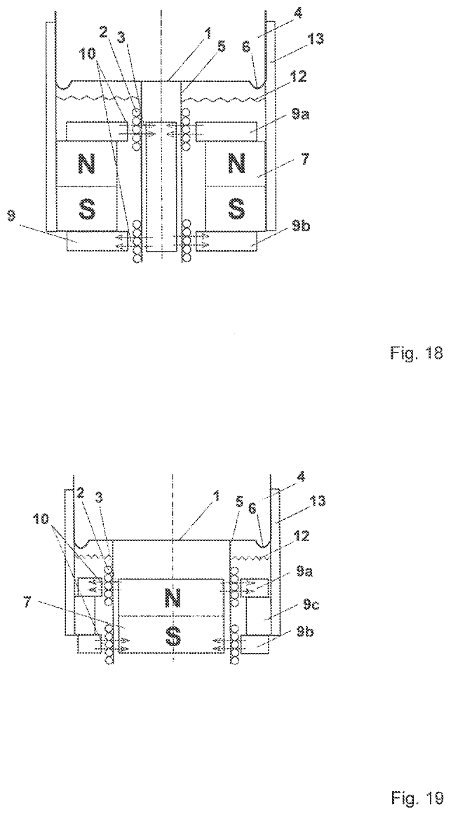

FIGS. 18 to 24 depict additional embodiments of an arrangement for a stimulation device or arrangements for the drive unit 32 and the pressure chamber 4. In each case, coil elements of an electromagnetic linear drive are movably or displaceably arranged in a stationary permanent magnetic field. For the same features, the same reference signs are used as in the preceding figures.

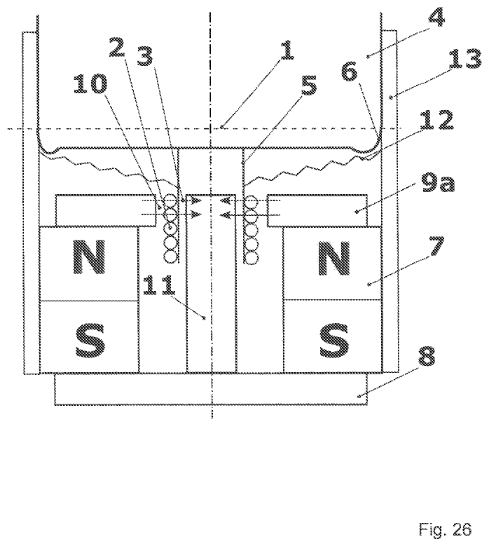

In the embodiments in FIGS. 18 to 24, the mount or bracket 12, which acts as a positioning or centering device for the carrier 5 having the (moving) coil 2, is shown in a neutral starting state, in which no deflection has taken place. In contrast to this, FIGS. 25 and 26 show a design in which carrier 5 having the moving coil 2 moves from the neutral starting or zero position (cf. FIGS. 18 to 24) downward into the stationary permanent magnetic field 3. Together with the carrier 5, the movable chamber wall portion 1 is hereby moved downward. During operation, the carrier 5 having the moving coil 2 and the movable chamber wall portion 1 oscillate about the neutral rest position, starting from the deflected starting position shown in FIGS. 25 and 26. In other embodiments, in particular the examples shown in FIGS. 18 to 24, oscillations occur about this neutral starting position starting from the neutral rest position shown in FIGS. 18 to 24.

The designs in FIGS. 25 and 26 make it possible in particular to apply an electrical current with non-changing polarity to the moving coil 2 in order to operate same. By contrast, a current with changing polarity is provided in other embodiments, for example in one or more of the embodiments in FIGS. 18 to 24. During operation, embodiments other than those shown in FIGS. 25 and 26 may also be operated about a deflected position that differs from the neutral rest or starting position.

In the embodiments in FIGS. 18 to 21, the coil 2 has an upper subcoil 2a and a lower subcoil 2b with separate coil windings. In regard to the examples in FIGS. 18 and 19, the upper and lower subcoils 2a, 2b are each arranged opposite pole plates 9, wherein the permanent magnets 7 are arranged on the outside (FIG. 18) or the inside (FIG. 19) in relation to the coil 2. The design supports arranged on the inside forming an optimized magnetic inductance.

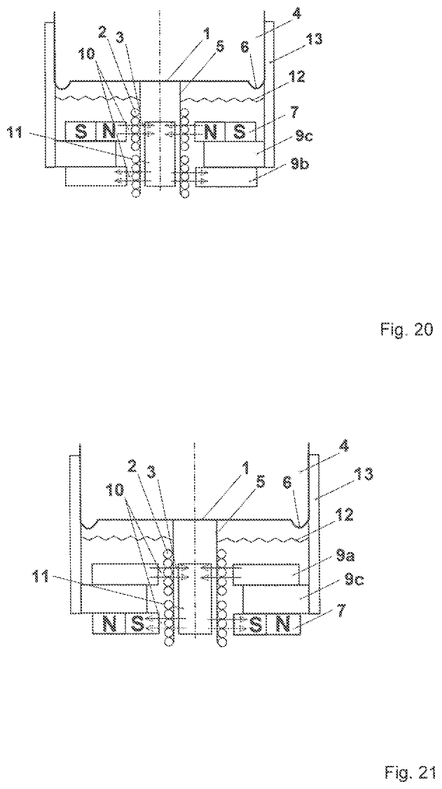

Also in the examples in FIGS. 20 and 21, the permanent magnets 7 are arranged on the outside in relation to the moving coil 2. The arrangement shown there of the permanent magnets 7, which, in comparison to the embodiment in FIG. 18, are arranged instead of the upper pole cap 9a or the lower pole cap 9b, supports a flat design.

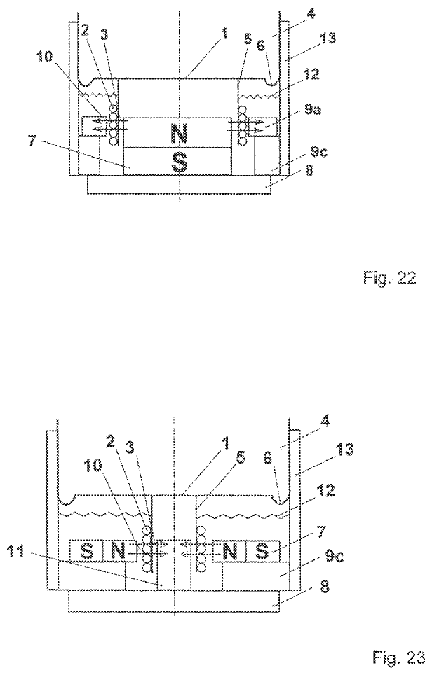

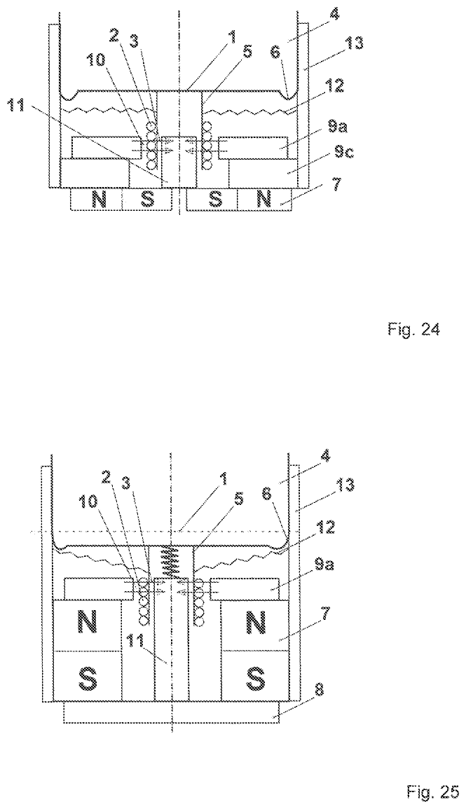

In comparison to the embodiments in FIGS. 18 to 21, the designs in FIGS. 22 to 24 use a one-piece coil 2, where here, too, the permanent magnets 7 may be arranged on the inside and outside in relation to the coil 2 according to FIGS. 22 and 23. In the design in FIG. 24, the permanent magnets 7 are arranged below the moving coil 2.

In the example in FIG. 18, upper and lower pole caps 9a, 9b are provided, which are arranged above and below the permanent magnets 7. In the embodiment in FIG. 19, the upper and lower pole caps 9a, 9b are arranged above and below, and in contact with, a central pole cap 9c.

In the embodiments in FIGS. 25 and 26, the permanent magnets 7 are arranged between, and in contact with, the upper pole plate 9a and the rear pole plate 8. According to FIG. 25, a spring 40 is provided, which provides a spring pretension against the depicted deflected position of the carrier 5 having the moving coil 2. FIG. 26 depicts an alternative design, in which the spring 40 is omitted. A pretension can be provided here by means of the mount/bracket 12.

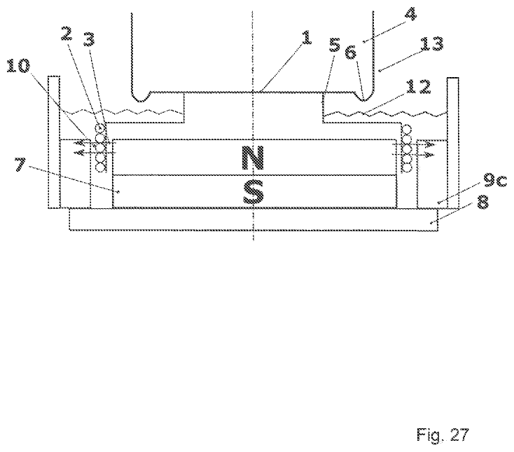

FIG. 27 depicts a design in which the coil device 2 encircles the permanent magnets 7 on the outside, in a manner comparable to the design in FIG. 22, wherein the depicted pole plates 9c can also be omitted as an option. In contrast to the design in FIG. 22, a regional diameter, which the coil device 2 encircles and in which the permanent magnets 7 are arranged, is greater than the diameter of the movable chamber wall portion 1. Alternatively, it may be provided (not depicted) that the regional diameter and the diameter of the movable chamber wall portion are essentially the same size. In this embodiment and others, the movable chamber wall portion 1 as well as the coil device 2 are arranged in a common central position (centered). Due to its selected structural properties, the design shown in FIG. 27 is particularly suited to execute a sufficient driving force for moving the movable chamber wall portion 1 about the (neutral) rest or starting position (in other words, rising and falling with respect to the rest and starting position) shown in FIG. 27 so that the desired variable pressure field can be generated in the small volumes.

The regional diameter, which corresponds to the diameter of the coil device 2, may be at a ratio of at least 0.3, alternatively at a ratio of at least 0.5 or 0.7, to the diameter of the movable chamber wall portion 1. For other embodiments, the ratio of the regional diameter (diameter of the coil device 2) to the diameter of the movable chamber wall portion 1 is at most 2, alternatively at most 1.8 or 1.5.

In regard to the embodiment of FIG. 27, the mount or bracket 12, which acts as a positioning or centering device for the support 5 having the (moving) coil 2, is shown in a neutral starting or rest position, in which no deflection has taken place. In contrast to this, FIGS. 25 and 26 show a design in which the support 5 having the moving coil 2 is moved out of the neutral starting or zero position (cf. FIG. 27) downward into the stationary permanent magnetic field 3.

The features disclosed in the preceding description, claims and drawings may be of significance both individually as well as in any combination for achieving the various embodiments.

1.-15. (canceled)

16. A device for stimulating a human erogenous zone, the device comprising:
a housing;
a drive device disposed in the housing, the drive device to provide a drive movement;
a pressure chamber disposed in the housing;
a wall, the drive device to cause at least a portion of the wall to repeatedly move between different wall positions to cause a volume of the pressure chamber to vary to cause pressure in the pressure chamber to modulate between positive pressures relative to an ambient pressure and negative pressures relative to the ambient pressure;
an opening fluidly connected to the pressure chamber, the positive pressures and the negative pressures to be output via the opening; and
a seal proximate to the opening, the seal to seal the pressure chamber with respect to an ambient environment,
the drive device including a movable coil through which an electrical current is to flow and a stationary permanent magnet, the movable coil disposed in a magnetic field of the stationary permanent magnet and coupled to the wall to transmit the drive movement to cause at least the portion of the wall to move, wherein at least a portion of the movable coil encircles the stationary permanent magnet and wherein a diameter of a region defined by the at least a portion of the movable coil encircling the stationary permanent magnet is equal to or greater than a diameter of the wall.

17. The device of claim 16, wherein a maximum volume of the pressure chamber is approximately 0.21.

18. The device of claim 16, wherein a minimum size of a diameter of the opening is approximately 5 mm and a maximum size of the diameter of the opening is approximately 50 mm.

19. The device of claim 16, wherein movement of at least the portion of the wall is to cause the volume of the pressure chamber is to increase by approximately 1% to approximately 25%.

20. The device of claim 16, wherein a minimum size of a diameter of the wall is approximately 5 mm and a maximum size of the diameter of the wall is approximately 60 mm.

21. The device of claim 16, wherein the diameter of the region corresponds to a diameter of the movable coil.

22. The device of claim 21, wherein a maximum ratio between the diameter of the region and a diameter of the wall is 2.

23. The device of claim 16, wherein at least a portion of the movable coil is carried by a carrier, the carrier coupled to the wall.

24. The device of claim 16, wherein movement of at least the portion of the wall is to cause the volume of the pressure chamber to decrease by approximately 1% to approximately 25%.

25. The device of claim 16, further including a battery to provide a drive energy for the drive device.

26. The device of claim 16, wherein the wall is rigid.

27. The device of claim 16, wherein the wall is a portion of a piston.

28. The device of claim 16, wherein the wall includes a flexible membrane.

29. A device for stimulating a human erogenous zone, the device comprising:
a housing;
a drive device disposed in the housing, the drive device to provide a drive movement;
a pressure chamber disposed in the housing;
a wall in the pressure chamber, the drive device to cause at least a portion of the wall to repeatedly move between different wall positions to cause a volume of the pressure chamber to vary to generate a variable pressure field of overpressures above an ambient pressure and underpressures below the ambient pressure;
an opening fluidly connected to the pressure chamber, the variable pressure field to be output via the opening in a form of the overpressures and the underpressures; and
a seal proximate to the opening, the seal to seal the pressure chamber with respect to an ambient environment;
the drive device including a movable coil through which an electrical current is to flow and a stationary permanent magnet, the movable coil disposed in a magnetic field of the stationary permanent magnet and coupled to the wall to transmit the drive movement to cause at least the portion of the wall to move,
wherein at least a portion of the movable coil encircles the stationary permanent magnet and wherein a diameter of the stationary permanent magnet is equal to or greater than a diameter of the wall.

30. The device of claim 29, wherein the wall is rigid.

31. The device of claim 29, wherein the wall is a portion of a piston.

32. The device of claim 29, wherein the wall includes a flexible membrane.

33. A device for stimulating a human erogenous zone, the device comprising:
a housing;
a drive device disposed in the housing, the drive device to provide a drive movement;
a pressure chamber disposed in the housing;
a wall, the drive device to cause at least a portion of the wall to repeatedly move between different wall positions to cause a volume of the pressure chamber to vary to cause pressure in the pressure chamber to modulate between positive pressures relative to an ambient pressure and negative pressures relative to the ambient pressure;
an opening fluidly connected to the pressure chamber, the positive pressures and the negative pressures to be output via the opening; and
a seal proximate to the opening, the seal to seal the pressure chamber with respect to an ambient environment,
the drive device including a movable coil through which an electrical current is to flow and a stationary permanent magnet, the movable coil carried by a carrier coupled to the wall and disposed in a magnetic field of the stationary permanent magnet to transmit the drive movement to cause at least the portion of the wall to move, wherein the carrier surrounds at least a part of the stationary permanent magnet and wherein an outer diameter of the carrier is equal to or greater than a diameter of the wall.

34. The device of claim 33, wherein the wall is a portion of a piston.

35. The device of claim 33, wherein the wall includes a flexible membrane.
